(19) United States
(12) Patent Application Publication
(10) Pub. No.: US 2006/0152170 A1
(43) Pub. Date: Jul. 13, 2006

(54) System for operating a plurality of negative dynamical impedance loads

(75) Inventors: Geert Willem Van Der Veen, Eindhoven (NL); Arnold Willem Buij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/562,890

(22) PCT Filed: Jun. 30, 2004
(86) PCT No.: PCT/IB04/51073

§ 371 Date: Dec. 29, 2005

(30) Foreign Application Priority Data
Jul. 4, 2003 (EP) 03102006.8

(51) Int. Cl. H05B 41/16

(52) U.S. Cl. 315/274

(57) ABSTRACT

A system (100A, 100B, 200, 300) for operating three gas discharge lamps (1A, 1B, 1C) using a common power source comprises three branches (110, 120, 130) connected in parallel between a first input node (A) and a second input node (102), wherein each branch comprises a lamp. The system comprises current equalizing means for ensuring that the currents in all branches are mutually substantially equal. The current equalizing means comprise two equalizing transformers (151, 152), wherein an equalizing transformer (151; 152) has one winding (114; 125) connected in series with one lamp (1A; 1B) and has another winding (124; 135) connected in series with another lamp (1B; 1C).

### FIELD OF THE INVENTION

The present invention relates in general to a system for operating a plurality of loads having a negative dynamical impedance using a common power source. Examples of such loads are fluorescent lamps (and other types of low-pressure or high-pressure gas discharge lamps). The present invention will be explained more specifically for a TL application, but it is explicitly noted that such explanation is not intended as limiting the scope of the invention.

### BACKGROUND OF THE INVENTION

For driving gas discharge lamps, special drivers have been developed, at least capable of driving one individual lamp. If it is desired to operate a plurality of lamps, it is of course possible to drive each individual lamp from a corresponding individual driver, but it would be more economical to use one common driver (also indicated as power source). Then, a problem is the question of how to connect the lamps to the common driver. A special problem is posed in the case of three substantially identical lamps.

In contrast to incandescent lamps, which have a resistive impedance, it is not possible to simply connect two or more discharge lamps in parallel, because then only one lamp would ignite and carry all current while the other lamps would remain off.

It is known in practice to connect three lamps 1A, 1B, 1C in series, as illustrated in FIG. 1A, where a common driver is indicated at 2. A disadvantage of such a series configuration is that the overall load voltage as seen by the driver is the summation of all three individual lamp voltages, which can be very high, especially when long, high-power lamps are driven in a dimming mode. Therefore, this method is only practically feasible for short, low-power lamps.

It is also known in practice to arrange three lamps 1A, 1B, 1C in an arrangement of two parallel branches 21 and 22, wherein a first branch 21 comprises two lamps 1A and 1B connected in series while the second branch 22 comprises only one lamp 1C, as illustrated in FIG. 1B. In the case where the three lamps are mutually substantially identical, the overall lamp voltage over the two lamps 1A and 1B in the first branch 21 is larger than the lamp voltage over the single lamp 1C in the second branch 22, which needs to be compensated by an equalizer transformer 10, having a first winding 11 in series with the first branch 21 and having a second winding 12 in series with the second branch 22. DC blocking capacitors 13 and 14 are shown incorporated in series with the first branch 21 and the second branch 22, respectively, for preventing DC currents in the lamps 1A, 1B, 1C. Since the equalizer transformer 10 must be capable of generating a voltage equal to the lamp voltage of the “missing” lamp, the transformer must be quite large in order to prevent core saturation: if the transformer core is saturated, proper equalizing is no longer ensured. Therefore, also this method is only practically feasible for short, low-power lamps.

U.S. Pat. No. 4,574,222 discloses a circuit for operating three discharge lamps, the circuit comprising a single current-balancing transformer having three transformer legs, each leg being provided with a winding which is connected in series with an associated lamp. A disadvantage of such a configuration is that a three-legged transformer is rather bulky and complicated, and such transformers are not commercially produced in large volumes so they are relatively costly. A further disadvantage is that the configuration is not easily extended to accommodate a further lamp. A further disadvantage is that the configuration does not provide effects which are equivalent for all lamps: especially the lamps associated with the outer transformer legs experience effects differing from the effects experienced by the lamp associated with the inner transformer leg.

A more fundamental disadvantage of using a three-legged transformer is the fact that such transformer is theoretically only capable of ensuring that the summation of all currents in the respective windings is zero, which offers no guarantee that the currents in the respective windings are mutually equal. Therefore, theoretically, it is possible that one of the windings carries no current at all.

### SUMMARY OF THE INVENTION

The present invention aims to provide a system for operating a plurality of lamps wherein the above-mentioned disadvantages are avoided.

More specifically, the present invention aims to provide a system capable of operating a plurality of mutually substantially identical lamps wherein the components of the system are relative simple components and wherein it is ensured that the currents in all lamps are mutually equal.

A further objective of the present invention is to provide a system capable of operating a plurality of mutually substantially identical lamps, comprising current equalizing transformer means for ensuring equal currents in all lamps, wherein the voltage over respective transformer windings remains relatively small.

According to an important aspect of the present invention, the lamps are all incorporated in parallel branches.

According to a further important aspect of the present invention, the current equalizing transformer means comprises a plurality of two-winding transformers, each transformer for equalizing the currents in its respective two windings.

### BRIEF DESCRIPTION OF THE DRAWINGS

These and other aspects, features and advantages of the present invention will be further explained by the following description of the present invention with reference to the drawings, in which same reference numerals indicate same or similar parts, and in which:

FIGS. 1A and 1B are circuit diagrams schematically illustrating prior art systems for operating three gas discharge lamps;

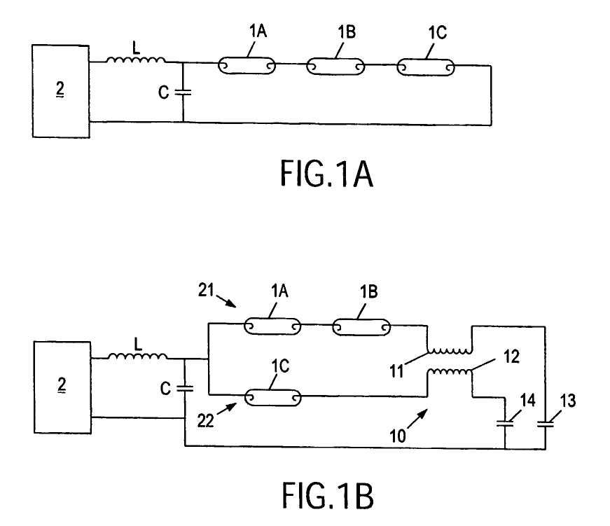

FIG. 2A is a circuit diagram schematically illustrating a first embodiment of a system for operating three gas discharge lamps in accordance with the present invention;

FIG. 2B is a circuit diagram schematically illustrating a variation of the first embodiment of FIG. 2A;

FIG. 3 is a circuit diagram schematically illustrating a second embodiment of a system for operating three gas discharge lamps in accordance with the present invention;

FIG. 4 is a circuit diagram schematically illustrating a third embodiment of a system for operating three gas discharge lamps in accordance with the present invention;

FIG. 5 is a block diagram schematically illustrating an extension of the first embodiment of FIG. 2A to a case of five lamps;

FIG. 6 is a block diagram schematically illustrating an extension of the second embodiment of FIG. 3 to a case of five lamps;

FIG. 7 is a block diagram schematically illustrating an extension of the third embodiment of FIG. 4 to a case of five lamps.

### DESCRIPTION OF THE INVENTION

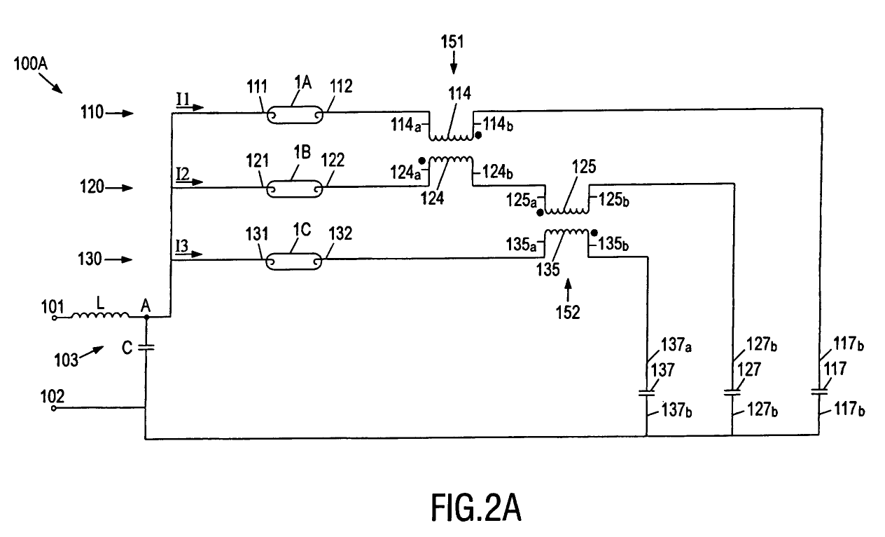

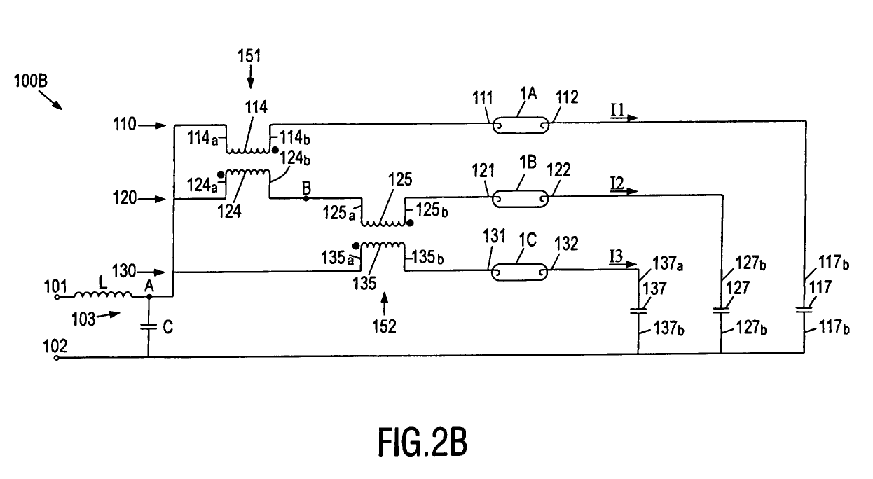

FIG. 2A schematically shows a circuit arrangement of a first system 100A for operating three gas discharge lamps 1A, 1B, 1C in parallel. It is assumed that the three lamps are mutually substantially identical, which will be the most practical situation. The system 100A has input terminals 101, 102 for connection to output terminals of a lamp driver (not shown). An input filter 103 comprises an inductor L and a capacitor C connected in series, wherein the inductor L has one terminal connected to a high-frequency signal input terminal 101 and wherein the capacitor C has one terminal connected to ground terminal 102. The node between inductor L and capacitor C is indicated is input node A.

The system 100A comprises three lamp branches 110, 120, 130 connected in parallel between said input node A and said ground terminal 102. Each branch comprises a series arrangement of a gas discharge lamp, at least one winding of an equalizer transformer, and a DC blocking capacitor.

More specifically:

The system 100A comprises a first equalizer transformer 151 having a first winding 114 and a second winding 124, with a winding ratio substantially equal to 1:1. The system 100A further comprises a second equalizer transformer 152 having a first winding 125 and a second winding 135, with a winding ratio substantially equal to 1:1.

The first lamp 1A, the first winding 114 of the first equalizer transformer 151, and a first DC blocking capacitor 117 are connected in series between said input node A and said ground terminal 102.

The second lamp 1B, the second winding 124 of the first equalizer transformer 151, the first winding 125 of the second equalizer transformer 152, and a second DC blocking capacitor 127 are connected in series between said input node A and said ground terminal 102.

The third lamp 1C, the second winding 135 of the second equalizer transformer 152, and a third DC blocking capacitor 137 are connected in series between said input node A and said ground terminal 102.

In FIG. 2A, lamp currents in lamps 1A, 1B, 1C are indicated as I1, I2, I3, respectively. First equalizer transformer 151 has a winding ratio 1:1, and its windings 114, 124 have mutually opposite direction, such that the first equalizer transformer 151 is effective to ensure that the currents I1 and I2 in first lamp 1A and second lamp 1B are mutually substantially equal, thus keeping the flux in its core equal to zero. Second equalizer transformer 152 also has a winding ratio 1:1, and its windings 125, 135 have mutually opposite direction, such that the second equalizer transformer 152 is effective to ensure that the currents I2 and I3 in second lamp 1B and third lamp 1C are mutually substantially equal, thus keeping the flux in its core equal to zero. Thus, all lamp currents I1, I2, I3 have substantially equal magnitude.

In principle, the order of the components may be chosen as desired in each lamp branch. For instance, as a variation in the arrangement 100A illustrated in FIG. 2A, the lamp and the corresponding transformer winding may switch places in each of the branches 110, 120, 130 independently from each other. For instance, in the arrangement illustrated in FIG. 2A, the first lamp 1A has one terminal 111 connected to input node A, and has its other terminal 112 connected to a first terminal 114a of the first winding 114 of the first equalizer transformer 151, which has its second terminal 114b connected to a first terminal 117a of the first DC blocking capacitor 117, which has its second terminal 117b connected to said ground terminal 102. As a variation, the first lamp 1A may have its first terminal 111 connected to the second terminal 114b of the first winding 114 of the first equalizer transformer 151, and have its second terminal 112 connected to the first terminal 117a of the first DC blocking capacitor 117, in which case the first terminal 114a of the first winding 114 of the first equalizer transformer 151 is connected to input node A. FIG. 2B illustrates a system 100B, in which said variation has been implemented in all branches 110, 120, 130.

Also, the DC blocking capacitor in a lamp branch may be arranged at any position in series with the lamp and the corresponding transformer winding. For instance, referring to FIG. 2A, the first DC blocking capacitor 117 may alternatively be arranged between node A and the first terminal 111 of the first lamp 1A, or between the second terminal 112 of the first lamp 1A and the first terminal 114a of the first winding 114 of the first equalizer transformer 151.

Further, instead of three individual blocking capacitors for each of the lamp branches, it is possible that one common blocking capacitor is used. Referring to FIG. 2A, this is equivalent to connecting the first terminals 117a, 127a, 137a of the three blocking capacitors 117, 127, 137 to each other.

When comparing the embodiments 100A and 100B of FIGS. 2A and 2B, embodiment 100A is preferred because embodiment 100B has the disadvantage that the transformer windings are connected to node A which carries a relatively highvoltage high-frequency signal. In this case, possible capacitive couplings between the transformer windings easily tend to give rise to parasitic currents.

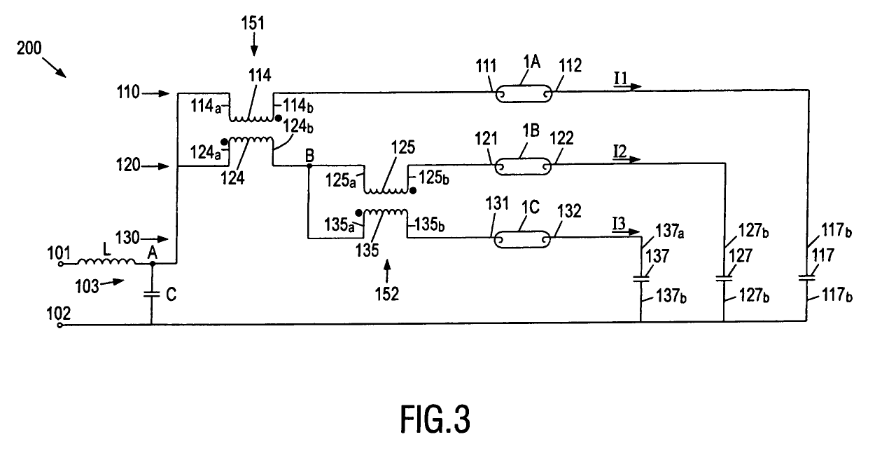

In the embodiments 100A and 100B of FIGS. 2A and 2B, each transformer winding (114), [124, 125], {135} is connected in series with exactly one lamp (1A), [1B], {1C} only. In an alternative approach, a transformer winding may be connected in series with an array of multiple lamps, each array being provided with equalizer means to ensure equal lamp current in each lamp of the array. FIG. 3 illustrates this approach for a system 200 where, similar to the embodiment 100B of FIG. 2B, all transformer windings are situated at the node A side of the corresponding lamps. In fact, the main difference between embodiment 200 of FIG. 3 and embodiment 100B of FIG. 2B is the fact that the first terminal 135a of the second winding 135 of the second transformer 152 is connected to the node B between the first terminal 125a of the first winding 125 of the second transformer 152 and the second terminal 124b of the second winding 124 of the first transformer 151, instead of being itself connected to node A.

In embodiment 200 of FIG. 3, each winding 125, 135 of the second transformer 152 is connected in series with exactly one lamp 1B, 1C, respectively, and the second transformer 152 is intended to ensure that the currents 12 and 13 in these lamps are mutually equal; hence, the second transformer 152 has a winding ratio 1:1. The first winding 114 of the first transformer 151 also is connected in series with exactly one lamp 1A, but the second winding 124 of the first transformer 151 is connected in series with the parallel arrangement of the two other lamps 1B and 1C, hence carries a current I2+I3 having a magnitude double the magnitude of the current I1 in the first winding 114. The first transformer 151 is intended to ensure that the current I1 in the first lamp 1A is equal to the currents 12 and 13 in the other two lamps 1B, 1C, in other words to ensure that the current I1 in its first winding 114 is half the current I2+I3 in its second winding 124. Therefore, the first transformer 151 has a winding ratio 2:1 in this case.

It is noted that, as a variation in each branch (110), [120], {130}, a lamp (1A), [1B], {IC} can switch places with the corresponding transformer winding (114), [125], {135}, similarly as explained above with reference to FIGS. 2A and 2B; this variation is not illustrated separately.

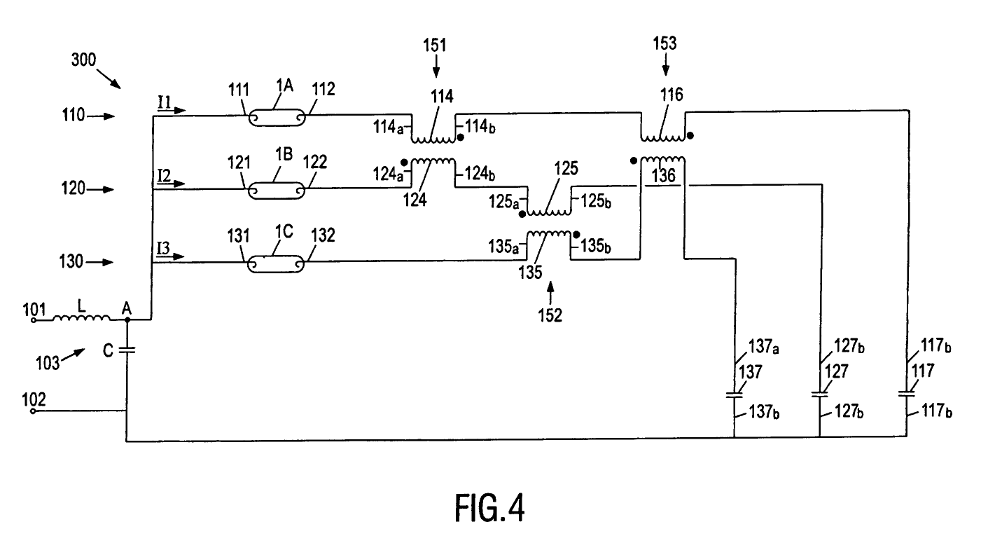

FIG. 4 illustrates a third system 300 for operating three gas discharge lamps 1A, 1B, 1C in parallel, in which the equalizing operation is symmetrical for all lamps. The third system 300 is comparable to the first system 100A of FIG. 2A, with the exception that a third equalizer transformer 153 is added for equalizing the currents I1 of the first lamp 1A and I3 of the third lamp 1C, i.e. for ensuring that the currents I1 and I3 in these lamps 1A and 1C are mutually equal. This third equalizer transformer 153 has a first winding 116 in series with the first lamp 1A and the first winding 114 of the first transformer 151, and has a second winding 136 in series with the third lamp 1C and the second winding 135 of the second transformer 152. This third equalizer transformer 153 has a winding ratio 1:1.

Each branch (110), [120], {130} now comprises a series arrangement of a lamp (1A), [1B], {1C} and two transformer windings (114, 116), [124, 125], {135, 136}. It is noted that, in each branch (110), [120], {130}, the order of the lamp (1A), [1B], {1C} and the corresponding transformer windings (114, 116), [124, 125], {135, 136} and the corresponding DC blocking capacitor (117), [127], {137} can be chosen as desired, similarly as explained above with reference to the embodiments 100A and 100B of FIGS. 2A and 2B. These variations are not separately illustrated. It is noted that FIG. 4 illustrates the preferred arrangement, in which the lamps (1A), [1B], {1C} have their respective first terminal (111), [121], {131} connected to said node A.

At first sight, it might appear that the third equalizer transformer 153 is superfluous. After all, in the above description of the first system 100A of FIG. 2A, it is already stated that the three lamp currents I1, I2 and I3 are mutually substantially equal. Nevertheless, when the third equalizer transformer 153 of FIG. 4 is added, a correct equalization of all three lamp currents I1, I2 and I3 can be more easily achieved with transformers which may have larger tolerance, i.e. less manufacturing restrictions, so that low-cost transformers can be used.

When comparing the systems 100A, 100B, 200, 300 discussed above, and their variations as mentioned, each may have advantages over the others.

A common advantage of the systems 100A and 100B of FIGS. 2A and 2B is the fact that all equalizer transformers 151 and 152 have winding ratio 1:1. In fact, all transformers 151 and 152 can be mutually identical.

The same applies to the system 300 of FIG. 4, which further has the advantage that all lamps are connected in series with the same amount of inductance (assuming that the transformers are selected to be mutually identical).

In the above, the present invention has been explained for a system comprising three gas discharge lamps. It should be clear to a person skilled in the art that these explanations are by way of example only, and are not intended to limit the scope of the invention. In fact, each example can easily be extended to four or more lamps.

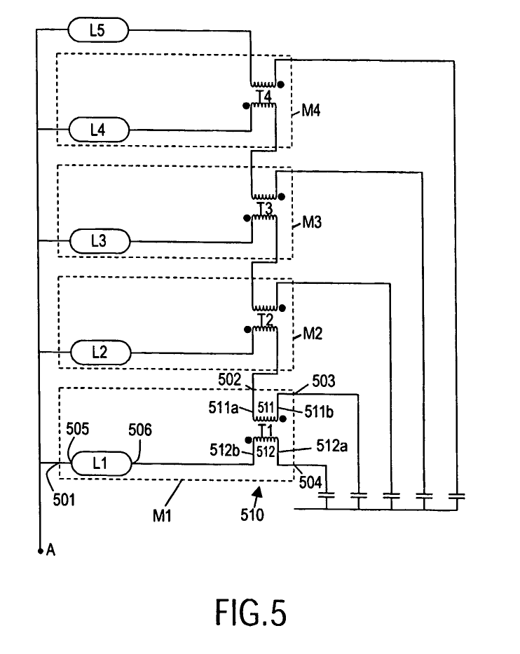

With respect to system 100A of FIG. 2A, extending this approach to a system comprising N lamps involves providing (N-1) equalizer transformers. The lamps can be numbered as L1, L2, L3, . . . LN, while the transformers can be numbered as T1, T2, T3, . . . T(N-1). Each lamp L1, L2, L3, . . . L(N-1) is connected in series with one terminal of the second winding of the corresponding transformer T1, T2, T3, . . . T(N-1). The last lamp LN is connected in series with one terminal of the first winding of transformer T(N-1). The free terminal of the second winding of each transformer Ti is connected in series with the first terminal of the first winding of transformer T(i-1). The free terminals of all lamps are connected to said node A. The free terminals of the first windings of the transformers are connected in series with a DC blocking capacitor, as is the second terminal of the second winding of the first transformer T1. This arrangement is schematically illustrated in FIG. 5 for a case of 5 lamps. It is noted that the transformers are connected such that the lamp currents in the two windings of each transformer cause mutually opposite flux directions, as indicated by black dots adjacent to the windings of the transformers.

Further, it is noted that, in each lamp branch, the order of lamp, transformer winding and blocking capacitor can be chosen as desired, similarly as already stated earlier. Also, two or more blocking capacitors may be connected together or replaced by one common capacitor for two or more branches.

An important advantage of this system is that it can easily be implemented as a modular arrangement. In FIG. 5, mutually identical modules are indicated as M1, M2, M3, . . . M(N-1). As is indicated for the first module M1, each module comprises:
a first input terminal 501 connected to a first contact 505 of a lamp socket;
a second input terminal 502 connected to a first terminal 511a of a first winding 511 of an equalizing transformer 510;
a third input terminal 503 connected to a second terminal 511b of the first winding 511 of the equalizing transformer 510;
a fourth input terminal 504 connected to a first terminal 512a of a second winding 512 of the equalizing transformer 510.

A second contact 506 of the lamp socket is connected to a second terminal 512b of the second winding 512 of the equalizing transformer 510.

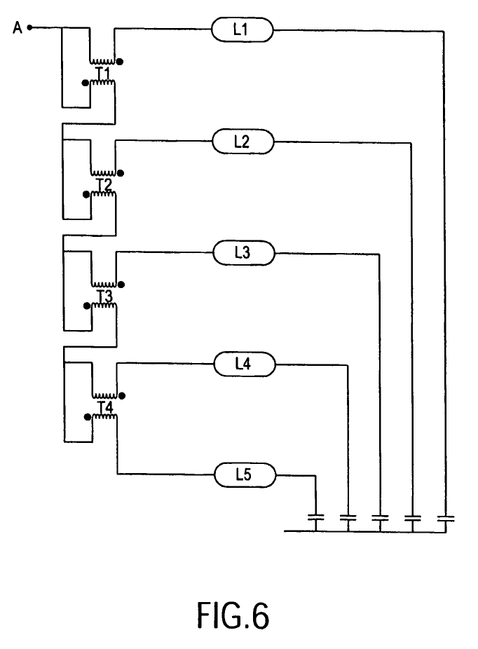

With respect to system 200 of FIG. 3, extending this approach to a system comprising N lamps involves providing (N-1) equalizer transformers. The lamps can be numbered as L1, L2, L3, . . . LN, while the transformers can be numbered as T1, T2, T3, . . . T(N-1). Each transformer T1, T2, T3, . . . T(N-1) has its windings connected together. Each lamp L1, L2, L3, . . . L(N-1) is connected in series with the free terminal of the first winding of the corresponding transformer T1, T2, T3, . . . T(N-1). The last lamp LN is connected in series with the free terminal of the second winding of transformer T(N-1). The node between both windings of transformer Ti is connected in series with the free terminal of the second winding of transformer T(i-1). The node between both windings of the first transformer T1 is connected to said node A. This arrangement is schematically illustrated in FIG. 6 for a case of 5 lamps.

Although this arrangement only requires N-1 transformers, it is a disadvantage that the transformers all have different winding ratios 1:1, 1:2, 1:3, . . . 1:(N-1). Further, each x-th lamp is connected in series with x windings, i.e. different lamps have mutually different numbers of windings connected in series.

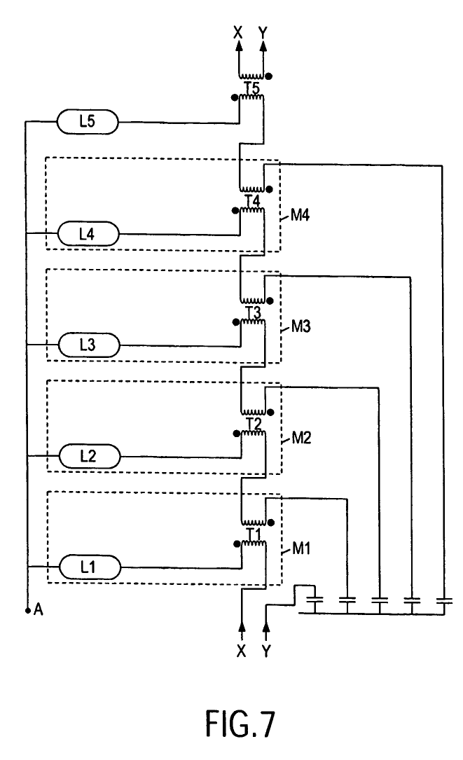

With respect to system 300 of FIG. 4, extending this approach to a system comprising N lamps involves providing N equalizer transformers. Such system can be obtained starting from an N-lamp system based on system 100A of FIG. 2A, as discussed above, and adding an N-th transformer coupling the N-th branch and the first branch. The arrangement as obtained is illustrated in FIG. 7. Each lamp branch will comprise a series arrangement of one lamp and 2 transformer windings, thus all lamps are connected in series with mutually the same amount of inductance (assuming that the transformers are selected to be mutually identical). Each lamp current is equalized with the current in a neighbouring branch.

It is possible to elaborate this system further, such that each lamp current is equalized with each of the other currents individually. This would involve providing (½)·N·(N-1) equalizer transformers, one for each possible pair of lamp branches. Each lamp branch will comprise a series arrangement of one lamp and (N-1) transformer windings, thus all lamps are connected in series with mutually the same amount of inductance (assuming that the transformers are selected to be mutually identical). However, the large number of transformers needed is a disadvantage.

It is noted that, in each of the above arrangements, each branch comprises only one lamp. Therefore, assuming that the lamps are mutually substantially equal, the voltage drops over the lamps will be mutually substantially equal, or at least the differences in voltage drops are expected to be relatively small. Thus, the voltages over the transformer windings, which correspond to the differences in lamp voltage drops, are expected to be relatively small, which means that the transformers can all have relatively small sizes.

In a possible practical implementation, a system comprising the current balancing equipment and the high-frequency driver circuitry can be accommodated in one common housing having a plurality of sockets for receiving corresponding lamps.

It is also possible that the high-frequency driver circuitry is accommodated in a first housing, having a high frequency output (node A), while a system comprising the current balancing equipment is accommodated in a second housing, separate from the first housing, having an input for coupling to said output of the first housing, and having a plurality of sockets for receiving corresponding lamps. This system is flexible in the sense that the second housing may be any of several types, containing, for instance, one or two or three etc. lamp sockets with associated high-frequency driver circuitry, and all of these types may be connected to the first housing.

It is even possible that the high-frequency driver circuitry is accommodated in a first housing, having a socket for receiving a lamp fitting or a lamp foot, this socket being connected to the high frequency output (node A), while a system comprising the current balancing equipment is accommodated in a second housing, separate from the first housing, having an input connector for coupling to said socket of the first housing, and having a plurality of sockets for receiving corresponding lamps. In such case, the input connector of the second housing has a design similar to a lamp fitting or a lamp foot.

It should be clear to a person skilled in the art that the present invention is not limited to the exemplary embodiments discussed above, but that various variations and modifications are possible within the protective scope of the invention as defined in the appending claims.

For instance, in the above explanation, each lamp branch contains only one lamp. However, the concept of the present invention is applicable in a broader sense. Each lamp branch should contain a lamp arrangement comprising at least one lamp connected in series. The voltage drops over the different lamp arrangements of the different lamp branches should be mutually substantially equal. For instance, the lamp arrangements may all comprise two or more lamps connected in series, all lamps being substantially equal. Or, one lamp arrangement may comprise two (or more) smaller lamps connected in series, while another lamp arrangement may comprise one larger lamp having the same voltage drop as said two (or more) smaller lamps together. Other combinations are also possible.

In the above explanation, it is mentioned that the transformers are two-winding transformers, i.e. transformers having two windings. It should be clear that a transformer used in implementing the present invention may comprise more than two windings, but the further windings remain not-connected, i.e. they are not operative.

Further, in the above, the invention is explained for implementations using current equalizing transformers. However, although such current equalizing transformers are preferred, indeed, the gist of the present invention is not restricted to the use of transformers. Actually, the present invention can be practiced with any kind of current equalizing device which comprises two current-sensitive members as well as means active and effective to set and maintain a predetermined ratio between the currents sensed by said members.

1. System (100A, 100B, 200, 300) for operating a plurality of loads (1A, 1B, 1C) having a negative dynamical impedance using a common power source;
the system comprising N branches (110, 120, 130) connected in parallel between a first input node (A) and a second input node (102), N being an integer larger than 2;
wherein each branch comprises a load arrangement containing at least one load connected in series;
the N load arrangements being selected such that, if each branch conducts the same current, the voltage drops over all loads are mutually substantially equal;
the system further comprising current equalizing means for ensuring that the currents in all branches are mutually substantially equal.

2. System (100; 300) according to claim 1, wherein said current equalizing means comprise a plurality of N-1 current equalizing devices (151; 152), wherein N-1 pairs of branches (110, 120; 120, 130) are always coupled together through one associated equalizing device (151; 152).

3. System (100; 300) according to claim 2, wherein the current equalizing devices comprise equalizing transformers, and wherein each equalizing transformer (151; 152) has one winding (114; 125) connected in series with the load arrangement (1A; 1B) of a first branch (110; 120) and has another winding (124; 135) connected in series with the load arrangement (1B; 1C) of a second branch (120; 130).

4. System (300) according to claim 2, further comprising an N-th equalizing device (153) coupling together an N-th pair of branches (130, 110).

5. System (300) according to claim 4, wherein the current equalizing devices comprise equalizing transformers, and wherein each branch (110; 120; 130) comprises a series arrangement of one load arrangement (1A; 1B: 1C) and two windings (114, 116; 124, 125; 135, 136) of corresponding transformers (151, 153; 151, 152; 152, 153).

6. System (200) according to claim 1, wherein said current equalizing means comprise a plurality of N-1 equalizing transformers (151, 152), wherein an equalizing transformer (151) has one winding (114) connected in series with one load arrangement (1A) and has another winding (124) connected in series with a parallel arrangement of a plurality of load branches (120, 130).

7. System according to claim 6, wherein said parallel arrangement of a plurality of load branches (120, 130) comprises another equalizing transformer (152) having a first winding (125) connected in series with one load arrangement (1B) and having another winding (135) connected in series with a parallel arrangement of at least one load branch (130).

8. System according to claim 7, wherein said first equalizing transformer (151) has its other winding (124) connected in series with a parallel connection of the two windings (125, 135) of said other equalizing transformer (152).

9. System (300) according to claim 1, wherein said current equalizing means comprise a plurality of (½)·N·(N-1) current equalizing devices (151, 152, 153), each pair of branches (110, 120; 110, 130; 120, 130) always being coupled together through one associated equalizing device (151; 152; 153).

10. System according to claim 1, wherein each branch (110; 120; 130) comprises a series arrangement of a load arrangement (1A; 1B; 1C) and at least one winding (114; 124, 125; 135) of at least one equalizing transformer (151; 151, 152; 152), wherein said load arrangement (1A; 1B; 1C) is arranged between a high-voltage input node (A) and said at least one winding (114; 124, 125; 135) of said at least one equalizing transformer (151; 151, 152; 152).

11. System according to claim 1, wherein a load comprises a gas discharge lamp.

12. System according to claim 1, wherein all loads are mutually substantially identical.

13. System according to claim 1, wherein N=3.

14. System according to claim 1, having an input terminal connected to the first input node (A) for coupling to an output terminal of a high frequency driver, and having a plurality of lamp sockets for receiving lamps (1A, 1B, 1C).

15. System according to claim 1, having an input connector for coupling to a lamp socket of a high frequency driver, the input connector having a design similar to a lamp fitting or a lamp foot.

16. Module (M1, M2, M3, M4) for a system according to claim 1, the module comprising:
a first input terminal (501) connected to a first contact (505) of a lamp socket;
a second input terminal (502) connected to a first terminal (511a) of a first winding (511) of an equalizing transformer (510);
a third input terminal (503) connected to a second terminal (511b) of the first winding (511) of the equalizing transformer (510);
a fourth input terminal (504) connected to a first terminal (512a) of a second winding (512) of the equalizing transformer (510);
a second contact (506) of the lamp socket being connected to a second terminal (512b) of the second winding (512) of the equalizing transformer (510).
